(19) United States
(12) Patent Application Publication
(10) Pub. No.: US 2026/0020543 A1
(43) Pub. Date: Jan. 22, 2026

(54) WHEELCHAIR DEVICE FOR MOBILITY-CHALLENGED QUADRUPEDS WITH USER-ACTUATED SIT-DOWN ACTION

(71) Applicant: HANDICAPPED PETS, INC., Amherst, NH (US)

(72) Inventors: Mark C. ROBINSON, Amherst, NH (US); James JONES, Derry, NH (US)

(21) Appl. No.: 18/996,699

(22) PCT Filed: Apr. 28, 2022
(86) PCT No.: PCT/US2022/026629

§ 371 Date: Jan. 17, 2025

(51) Int. Cl. A01K 29/00

(52) U.S. Cl. CPC A01K 29/00

(57) ABSTRACT

A wheelchair device for mobility-challenged quadrupeds is disclosed. The device is configured with a user-actuated sit-down action in which an actuator element may be actuated by a user to allow the device to transition from an upright state to a collapsed state. Deflection of the actuator element causes latching element(s) to disengage from corresponding pin(s), whereupon the leg(s) of the device may be permitted to rotate relative to the frame of the device. Thus, as the quadruped initiates a “sitting down” motion, the leg(s) may pivot up alongside the frame to achieve an orientation generally parallel with the frame, putting the device in a collapsed state that permits the quadruped to sit and/or lay down safely, naturally, and comfortably. The device further includes one or more ratchet assemblies that lock the wheel(s) and help drive the device back up to its upright state when the quadruped attempts to move forward.

### FIELD OF THE DISCLOSURE

The present disclosure relates to mobility aids for animals and, more particularly, to wheelchair devices for mobility-challenged quadrupeds.

BACKGROUND

Quadruped animals, such as dogs and cats, can lose the use of their hindleg(s) due to any of a wide range of factors, including injury, illness, age, and obesity, to name a few. Disabling medical conditions include inherited degenerative disorders, disc rupture, and primary diseases of the nervous system. Unable to walk/run and exercise, the animal often becomes lethargic, giving rise to additional health and care problems.

### SUMMARY

A first example embodiment provides a wheelchair device for a quadruped. The wheelchair device includes a frame configured to have the quadruped situated therein. The wheelchair device also includes at least one leg connected to the frame. The wheelchair device also includes at least one wheel assembly connected to the at least one leg. The wheelchair device also includes an actuator assembly operatively coupled with the at least one leg. The actuator assembly includes an actuator element configured to be actuated by a user. The actuator assembly also includes at least one latching element configured to be engaged with at least one structural feature of the at least one leg. The actuator element is operatively coupled with the at least one latching element such that actuation of the actuator element by the user causes disengagement of the at least one latching element from the at least one structural feature to permit the wheelchair device to transition from an upright state to a collapsed state.

In some cases of the noted first example embodiment, in being configured to be actuated by the user, the actuator element is configured to be manually pulled or pushed toward the frame by the user. In some such instances, the actuator element includes a handle. In some such instances, the handle is configured as an elongate bar extending generally perpendicular to a longitudinal length of the frame.

In some cases of the noted first example embodiment, the at least one structural feature is configured as a pin extending from the at least one leg into an interior region of the frame.

In some cases of the noted first example embodiment, the frame is configured to at least partially accommodate hindquarters of the quadruped.

In some of the aforementioned cases of the noted first example embodiment, the at least one wheel assembly includes a wheel. The at least one wheel assembly also includes a ratchet assembly. The ratchet assembly includes a gear operatively connected with the wheel. The ratchet assembly also includes a pawl configured to operatively interface with the gear to prevent rotation of the wheel in one direction. In some such instances, the pawl is configured as a pendulum latch. In some such instances, the pawl is configured to: prevent rotation of the wheel in the one direction when the wheelchair device is in the collapsed state; and permit rotation of the wheel in two directions when the wheelchair device is in the upright state. In some such instances: the at least one wheel assembly further includes a hub disposed adjacent to the wheel; and the ratchet assembly is at least partially disposed within the hub.

In some of the aforementioned cases of the noted first example embodiment, the wheelchair device further includes at least one adjustable knuckle clamp assembly connected to the at least one leg and to the frame, wherein the at least one knuckle clamp assembly is configured to orient the at least one leg with respect to the frame. In some such instances, the at least one adjustable knuckle clamp assembly includes a tensioning element. The at least one adjustable knuckle clamp assembly also includes a tension selector element interfaced with the tensioning element. The at least one adjustable knuckle clamp assembly also includes a tension locking element interfaced with the tension selector element. In some such instances, the tensioning element includes a torsion spring. In some such instances, the tension selector element includes one or more structural features configured to interface with the tensioning element so as to change a tension level provided via interfacing of the tensioning element with the tension selector element. In some such instances, the tension locking element includes a detent pin configured to interface with the tension selector element so as to fix a tension level provided via interfacing of the tensioning element with the tension selector element. In some such instances, the at least one wheel assembly is connected to the at least one leg at an end of the at least one leg which is distal to the at least one adjustable knuckle clamp assembly.

A second example embodiment provides a wheelchair device for a quadruped. The wheelchair device includes a frame configured to at least partially accommodate hindquarters of the quadruped. The wheelchair device also includes one or more legs connected to the frame by a corresponding one or more adjustable knuckle clamp assemblies. The wheelchair device also includes one or more wheel assemblies connected to the one or more legs. The wheelchair device also includes an actuator assembly operatively coupled with the one or more legs and configured to transition the wheelchair device from an upright state in which the one or more legs are oriented substantially perpendicular to a longitudinal length of the frame to a collapsed state in which the one or more legs are oriented substantially parallel to the longitudinal length of the frame. The actuator assembly includes an actuator element configured to be actuated by a user. The actuator assembly also includes one or more latching elements configured to be engaged with the one or more legs. The actuator element is operatively coupled with the one or more latching elements such that actuation of the actuator element by the user causes disengagement of the one or more latching elements from the one or more legs to permit the wheelchair device to transition from the upright state to the collapsed state.

In some cases of the noted second example embodiment, the one or more wheel assemblies each include a wheel. The one or more wheel assemblies each also include a gear operatively connected with the wheel. The one or more wheel assemblies each also include a pawl configured to operatively interface with the gear to prevent rotation of the wheel in one direction when the wheelchair device is in the collapsed state, wherein the pawl is configured as a pendulum latch.

In some cases of the noted second example embodiment, the one or more adjustable knuckle clamp assemblies each include a pre-wound torsion spring. The one or more adjustable knuckle clamp assemblies each also include a selector plate with a plurality of stops that provide a corresponding plurality of tension levels for the pre-wound torsion spring. The one or more adjustable knuckle clamp assemblies each also include a detent pin configured to serve as an index stop that allows the user to set the tension level of the pre-wound torsion spring by changing a number of winds of the pre-wound torsion spring.

In some of the aforementioned cases of the noted second example embodiment, the actuator element includes a handle configured to be manually pulled or pushed by the user toward a rear portion of the frame.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1A illustrates a wheelchair device configured in accordance with an embodiment of the present disclosure, with the wheelchair device in an upright state.

FIG. 1B illustrates a wheelchair device configured in accordance with an embodiment of the present disclosure, with the wheelchair device in a collapsed state.

FIG. 2A illustrates the wheelchair device of FIG. 1A with a partial/reduced view of a wheel assembly configured in accordance with an embodiment of the present disclosure.

FIG. 2B illustrates a close-up view of the wheel assembly of FIG. 2A configured in accordance with an embodiment of the present disclosure.

FIG. 3A illustrates the wheelchair device of FIG. 1B with a partial/reduced view of a wheel assembly configured in accordance with an embodiment of the present disclosure.

FIG. 3B illustrates a close-up view of the wheel assembly of FIG. 3A configured in accordance with an embodiment of the present disclosure.

FIG. 4A illustrates a partial/reduced view of an actuator assembly of the wheelchair device configured in accordance with an embodiment of the present disclosure, with the actuator assembly in an unactuated state.

FIG. 4B illustrates another view of the actuator assembly of FIG. 4A, in accordance with an embodiment of the present disclosure.

FIG. 5A illustrates a partial/reduced view of an actuator assembly of the wheelchair device configured in accordance with an embodiment of the present disclosure, with the actuator assembly in an actuated state.

FIG. 5B illustrates another view of the actuator assembly of FIG. 5A, in accordance with an embodiment of the present disclosure.

FIG. 6A illustrates a view of an adjustable knuckle clamp assembly of the wheelchair device configured in accordance with an embodiment of the present disclosure.

FIG. 6B illustrates a partial/reduced view of the adjustable knuckle clamp assembly of FIG. 6A, in accordance with an embodiment of the present disclosure.

FIG. 7A illustrates a view of an adjustable knuckle clamp assembly of the wheelchair device configured in accordance with an embodiment of the present disclosure, with the tension locking element in a locked state.

FIG. 7B illustrates a partial/reduced view of the adjustable knuckle clamp assembly of FIG. 7A, in accordance with an embodiment of the present disclosure.

FIG. 8A illustrates a view of an adjustable knuckle clamp assembly of the wheelchair device configured in accordance with an embodiment of the present disclosure, with the tension locking element in an unlocked state.

FIG. 8B illustrates a partial/reduced view of the adjustable knuckle clamp assembly of FIG. 8A, in accordance with an embodiment of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

### DETAILED DESCRIPTION

A wheelchair device for mobility-challenged quadrupeds is disclosed. The device is configured, in accordance with some embodiments, with a user-actuated sit-down action. To that end, the device includes an actuator element that may be actuated by a user (e.g., gripped or otherwise operated) to allow the device to transition from an upright state to a collapsed state. More specifically, the actuator element may be deflected (e.g., pulled or pushed) in a given direction to cause one or more latching elements to disengage from one or more corresponding pins. Upon such disengagement, the one or more legs of the device may be permitted to rotate relative to the frame of the device. Thus, as the quadruped initiates a “sitting down” motion (e.g., under the action of gravity and/or with user assistance), the one or more legs of the device may pivot up alongside the frame to achieve an orientation generally parallel with the length of the frame, putting the device in a collapsed or folded state that permits the quadruped to sit and/or lay down safely, naturally, and comfortably. The device further includes one or more ratchet assemblies that lock the one or more wheels of the device and help drive the device back up to its upright state when the quadruped attempts to move forward. Numerous configurations and variations will be apparent in light of this disclosure.

### General Overview

Some existing wheelchair-type devices for quadrupeds pose a safety risk, in that the tail and/or hindleg(s) of the quadruped can become trapped or pinched by the frame or the legs. Also, some existing devices for quadrupeds have structural features which undesirably constrain the movement of the quadruped, such as in the case where the animal may have worked itself into the corner of a room and is prevented from moving in reverse by the wheelchair device, leading to frustration both for the animal and the owner. Moreover, some existing devices must be made to order and custom-designed to the measurements of the animal and, because of this, normally cannot be returned or used on another animal unless the other animal has the same body measurements as the original animal for which the cart was made. Additionally, some existing devices are bulky and difficult to transport.

Thus, and in accordance with some embodiments of the present disclosure, a wheelchair device for mobility-challenged quadrupeds is disclosed. The device is configured, in accordance with some embodiments, with a user-actuated sit-down action. To that end, the device includes an actuator element that may be actuated by a user (e.g., gripped or otherwise operated) to allow the device to transition from an upright state to a collapsed state. More specifically, the actuator element may be deflected (e.g., pulled or pushed) in a given direction to cause one or more latching elements to disengage from one or more corresponding pins. Upon such disengagement, the one or more legs of the device may be permitted to rotate relative to the frame of the device. Thus, as the quadruped initiates a “sitting down” motion (e.g., under the action of gravity and/or with user assistance), the one or more legs of the device may pivot up alongside the frame to achieve an orientation generally parallel with the length of the frame, putting the device in a collapsed or folded state that permits the quadruped to sit and/or lay down safely, naturally, and comfortably.

In the collapsed state, the one or more wheels of the device may be prevented from rotating forward about their axles by one or more corresponding ratchet assemblies, in accordance with some embodiments. More specifically, within a given ratchet assembly in the collapsed state, a gear may be locked in position by a corresponding pawl (e.g., a pendulum latch). Thus, when the quadruped attempts to move forward (e.g., under its own power using its forelegs and/or with user assistance), the locked wheel(s) may help to drive the device back up to its upright state, and the one or more ratchet assemblies then may disengage, thereby allowing free travel of the device in the upright state.

In accordance with some embodiments, the device optionally may include one or more adjustable knuckle clamp assemblies configured to set the relative ease with which the one or more corresponding legs pivot relative to the frame. In this manner, the one or more knuckle clamp assemblies may dictate the ease with which the device is permitted to transition from its upright state to its collapsed state, and thus the device may be adjusted to accommodate quadrupeds of various sizes, weights, and mobility levels. As discussed herein, a given adjustable knuckle clamp assembly may include, in accordance with some embodiments, a pre-wound torsion spring that provides lift, a selector plate with a series of stops that cooperate to provide a given tension level (e.g., resistance to transitioning from the upright state to the collapsed state), and a detent pin that acts as an index stop which allows the user to set the desired tension level by increasing/decreasing the number of winds of the torsion spring.

As described herein, the disclosed device may be configured, in accordance with some embodiments, to interface with the hindquarters of a quadruped that is mobility-challenged. More specifically, the caudal end of a quadruped may be situated within the confines of the frame of the device, with the legs and wheel assemblies of the device generally disposed proximate the hindlegs of the quadruped. As will be appreciated in light of this disclosure, the disclosed device may be utilized with quadrupeds whose mobility is diminished, for instance, as a result of age, injury, disease, birth defect, or other disabling source or factor. As will be further appreciated, the disclosed device may be utilized with any of a wide range of pets, service animals, and livestock, among other types of quadrupeds.

In accordance with some embodiments, the disclosed device may realize one or more benefits or advantages as compared to existing approaches. For instance, in at least some cases, the disclosed device may provide a greater level of safety to the quadruped than existing approaches, in that employing user-actuated transitioning of the device into the collapsed state may protect the quadruped from self-injury when sitting or lying down. Additionally, when not currently in use by a quadruped, the disclosed device may be collapsed for stowage and transportation more easily than existing approaches, at least in some cases.

### Structure

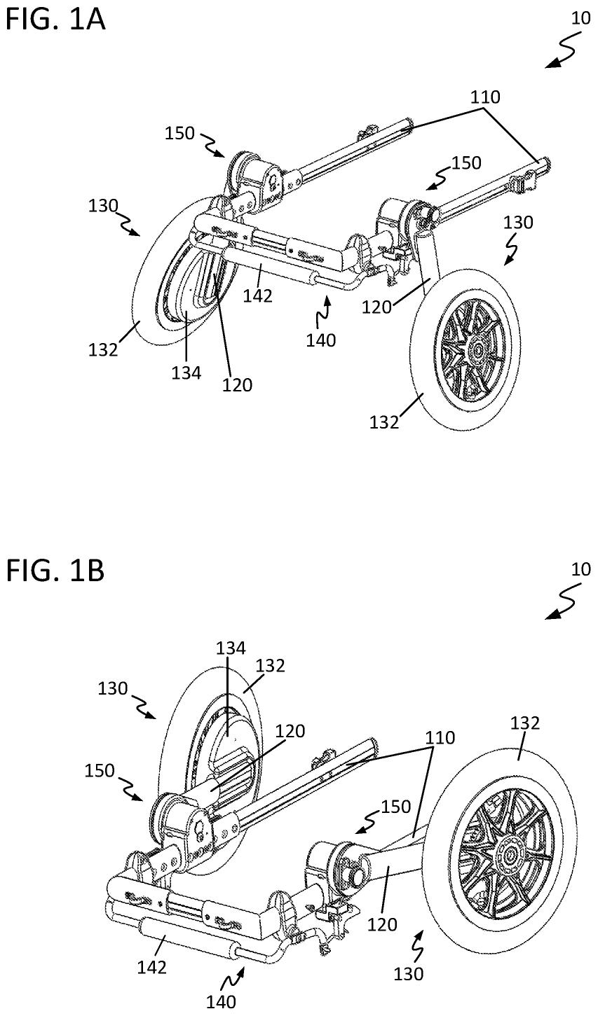

FIGS. 1A-1B illustrate a wheelchair device 10 (hereinafter, device 10) configured in accordance with an embodiment of the present disclosure. Specifically, FIG. 1A shows device 10 in an uncollapsed (e.g., upright) state, whereas FIG. 1B shows device 10 in a collapsed (e.g., sitting or lying down) state. As can be seen, device 10 may include: a frame 110; one or more legs 120 connected to frame 110 by one or more corresponding adjustable knuckle clamp assemblies 150; one or more wheel assemblies 130 connected to the one or more corresponding legs 120; and an actuator assembly 140. Each of these elements is discussed in turn below. In a general sense, device 10 may be configured, in accordance with some embodiments, to serve as a wheelchair-like mobility aid suitable for assisting mobility-challenged quadrupeds with performing any of a wide range of movements, including, for example, walking, running, sitting, and lying down in a safe, natural, and comfortable manner.

As previously noted, device 10 may include a frame 110, the general construction of which may be customized, as desired for a given target application or end-use. Frame 110 may be configured, in accordance with some embodiments, to at least partially encompass the hindquarters of a quadruped situated therein. As generally shown, frame 110 may be substantially U-shaped, though other shapes may be provided (e.g., V-shaped, C-shaped, parallel rails, etc.), as desired. In accordance with some embodiments, frame 110 may be configured to support a harness for the quadruped and, to that end, may include one or more harness connectors (or other suitable structures, as will be apparent in light of this disclosure). In some embodiments, frame 110 may be adjustable in one or more dimensions (e.g., adjustable in its longitudinal length and/or its transverse width).

Also, as previously noted, device 10 may include one or more legs 120, the general construction of which may be customized, as desired for a given target application or end-use. A given leg 120 may be configured, in accordance with some embodiments, to extend substantially perpendicular to frame 110 in the upright state of device 10 and substantially parallel to frame 110 in the collapsed state of device 10, with the ability to rotate through whatever angle range is desired to achieve those and other intermediate orientations. In accordance with some embodiments, a given leg 120 may be configured to support at least a portion of the weight of the quadruped while allowing device 10 to move in a given direction utilizing one or more wheel assemblies 130 (discussed below). In some embodiments, a given leg 120 may be adjustable in one or more dimensions (e.g., adjustable in its longitudinal length and/or camber angle relative to frame).

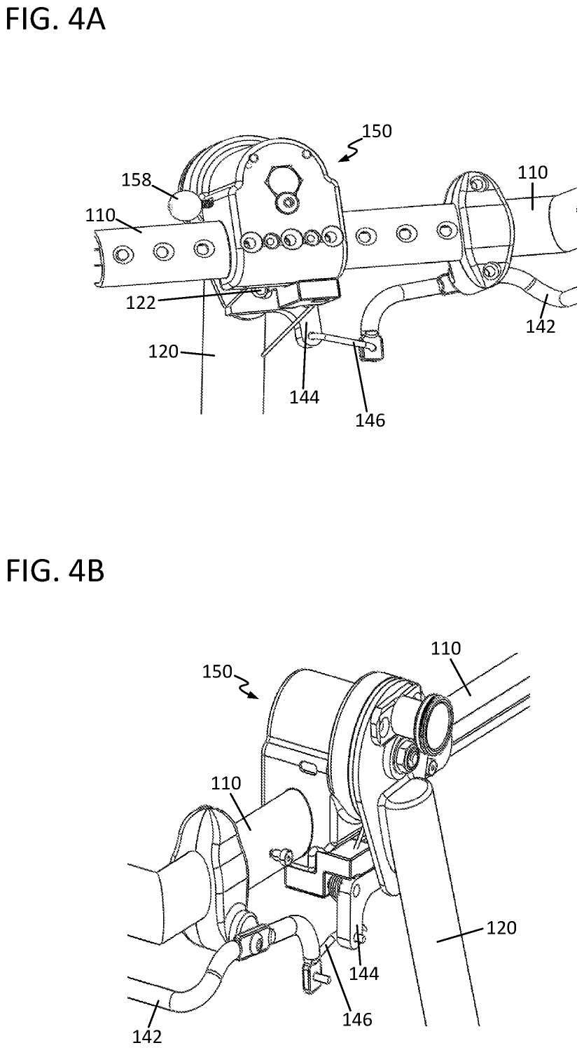

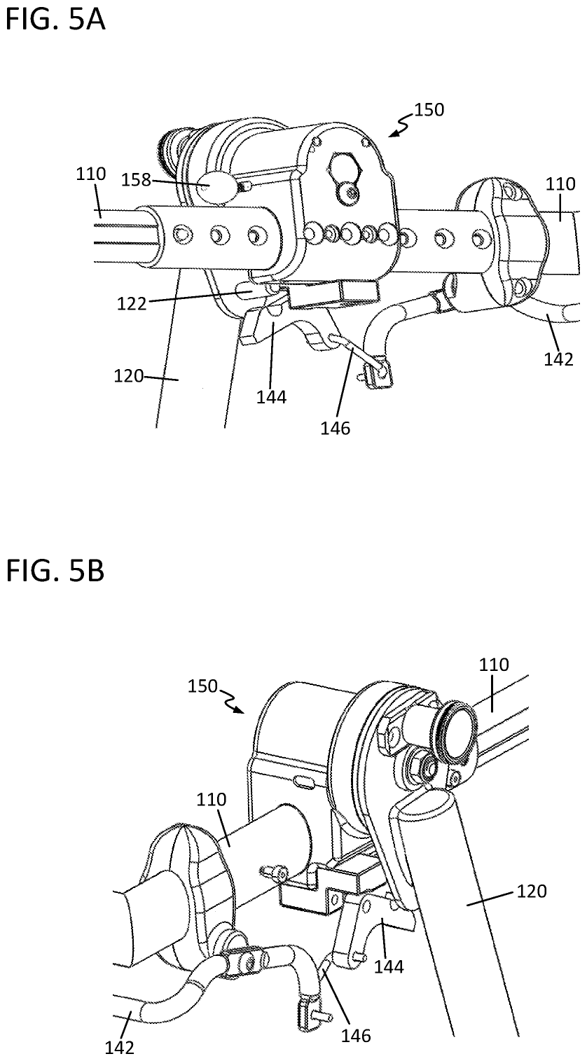

Turning briefly to FIGS. 4A and 5A (discussed further below), a given leg 120 may include a pin 122 disposed at or near an end connected to frame 110 (e.g., via an associated knuckle clamp assembly 150, discussed below). A given pin 122 may be configured, in accordance with some embodiments, to interface with a corresponding latching element 144 (of actuator assembly 140, discussed below) to effectuate locking of an associated leg 120 in an orientation which maintains device 10 in its upright state, as described herein. To that end, the geometry and dimensions of a given pin 122 may be customized, as desired for a given target application or end-use. As can be seen, a given pin 122 generally may extend outward from its associated leg 120, generally toward the interior region of frame 110. It should be noted, however, that the present disclosure is not intended to be so limited only to a pin 122 as providing the above-noted functionality, as in a more general sense, and in accordance with some embodiments, other suitable structural features such as an eyelet, a hoop, or an L-shaped projection alternatively (or additionally) may be utilized. Numerous suitable options and configurations will be apparent in light of this disclosure.

As previously noted, device 10 further may include one or more wheel assemblies 130. As can be seen from FIGS. 1A-1B, a given wheel assembly 130 may include a wheel 132 mounted on an associated axle disposed at or near a distal end of a corresponding leg 120 (e.g., distal to an associated knuckle clamp assembly 150 or, more generally, frame 110). The type and dimensions of a given wheel 132 may be customized, as desired for a given target application or end-use.

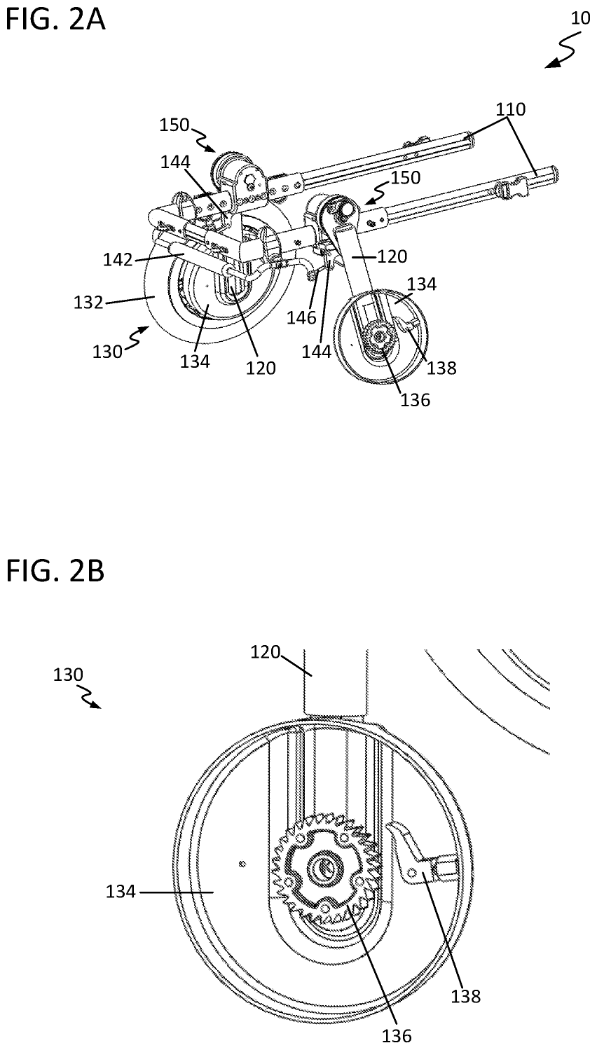

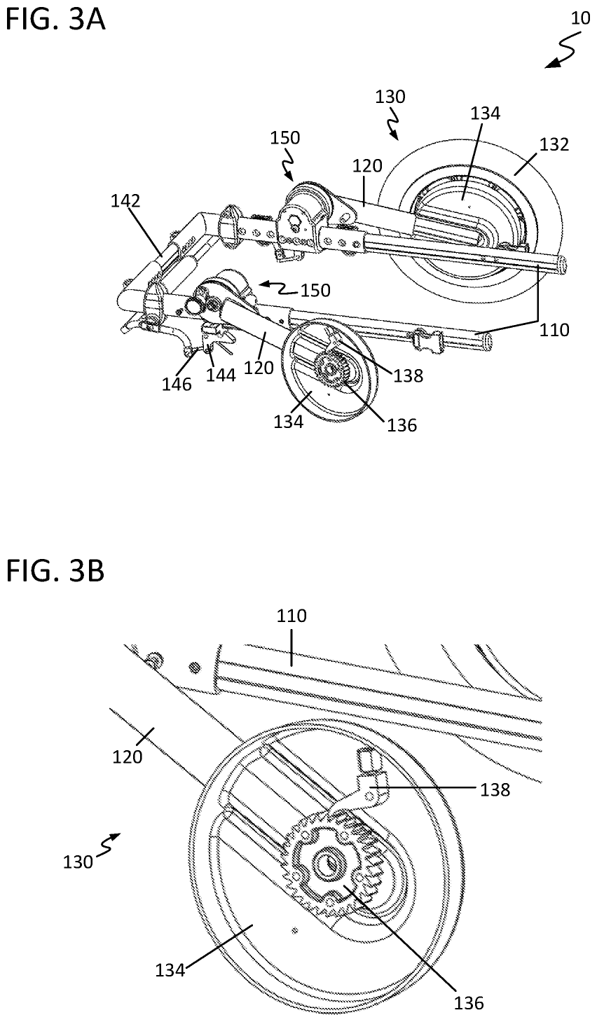

Also, as can be seen from FIGS. 1A-1B, a given wheel assembly 130 may include a hub 134 disposed adjacent a given wheel 132. In accordance with some embodiments, hub 134 may have disposed therein a gear 136 and a pawl 138 that cooperate to provide an associated wheel assembly 130 with a ratcheting action which depends, at least in part, on the state of device 10. For instance, consider FIGS. 2A-2B and FIGS. 3A-3B, which illustrate several views of a wheel assembly 130 of device 10 configured in accordance with an embodiment of the present disclosure. As can be seen, when device 10 is in its upright state (FIGS. 2A-2B), pawl 138 may not be in contact with gear 136 within hub 134. Thus, in the upright state of device 10, wheel 132 may be permitted to rotate freely in either direction about its axle. However, when device 10 is in its collapsed state (FIGS. 3A-3B), pawl 138 may be in contact with gear 136 within hub 134. Thus, in the collapsed state of device 10, wheel 132 may be permitted to rotate freely in only one direction about its axle. For example, in the collapsed state, device 10 may be permitted to roll rearward (e.g., in the direction of the caudal end of the quadruped) but prevented from rolling forward (e.g., in the direction of the cephalic end of the quadruped) on wheel(s) 132. In this manner, when the quadruped attempts to move forward (e.g., under its own power using its forelegs and/or with user assistance), wheel(s) 132 (as locked by the interfacing of pawl(s) 138 with gear(s) 136) may help to drive device 10 back up to its upright state. In entering the upright state, pawl(s) 138 may disengage gear(s) 136, thereby once again allowing free travel of device 10 in the upright state. To that end, a given pawl 138 may be configured, in accordance with some embodiments, as a pendulum latch.

Also, as previously noted, device 10 may include an actuator assembly 140. For instance, consider FIGS. 4A-4B and FIGS. 5A-5B, which illustrate several views of an actuator assembly 140 of device 10 configured in accordance with an embodiment of the present disclosure. As can be seen, actuator assembly 140 may include an actuator element 142 and one or more latching elements 144, optionally with one or more intervening linkage elements 146. Each of these elements is discussed in turn below.

Actuator element 142 may be configured, in accordance with some embodiments, to allow device 10 to transition from an upright state to a collapsed state. To that end, actuator element 142 may be configured, in accordance with some embodiments, to be deflected (e.g., pulled or pushed) in a given direction by a user to cause one or more latching elements 144 (discussed below) to disengage from one or more corresponding pins 122 (discussed above), thereby allowing such transition. In at least some instances, actuation of actuator element 142 may be performed by the user gripping actuator element 142 in one hand (or both hands) and pulling (e.g., upward or downward) or pushing (e.g., upward or downward) on actuator element 142 to bring actuator element 142 more proximal to frame 110. In some other instances, actuation of actuator element 142 may be performed by the user gripping both a rear portion of frame 110 and actuator element 142 in one hand (or both hands) and squeezing to bring actuator element 142 more proximal to the rear portion of frame 110.

In some embodiments, actuator element 142 may be (or otherwise may include), for example, a handle. In some embodiments, actuator element 142 may be configured as an elongate bar that extends generally perpendicular to the longitudinal length of frame 110 (e.g., substantially parallel to the transverse width of frame 110). In accordance with some embodiments, actuator element 142 may be disposed at or near a rear of frame 110 (e.g., a portion of frame 110 to be situated near a caudal end of the quadruped). The geometry and dimensions of actuator element 142 may be customized, as desired for a given target application or end-use. As will be appreciated in light of this disclosure, it may be desirable, at least in some instances, to ensure that actuator element 142 is sized and shaped for manual manipulation by a user. Numerous suitable options and configurations for actuator element 142 will be apparent in light of this disclosure.

As can be seen further from FIGS. 4A and 5A, one or more latching elements 144 may be operatively connected to actuator element 142 such that, upon actuation of actuator element 142, latching element(s) 144 disengage one or more corresponding pins 122, in accordance with some embodiments. Upon disengagement of latching element(s) 144 from pin(s) 122 (see FIGS. 5A-5B), the one or more legs 120 of device 10 may be permitted to rotate relative to frame 110. For instance, leg(s) 120 may pivot up alongside frame 110 to achieve an orientation generally parallel with the longitudinal length of frame 110 in the collapsed state (see FIG. 1B). Leg(s) 120 also may pivot down from alongside frame 110 to achieve an orientation generally perpendicular to the longitudinal length of frame 110 in the upright state (see FIG. 1A). To such ends, the geometry and dimensions of a given latching element 144 may be customized, as desired for a given target application or end-use. Also, it should be noted further that the present disclosure is not intended to be so limited only to a latching element 144 configured to interface with a pin 122 as variously described herein, as in a more general sense, and in accordance with some embodiments, latching element 144 may be configured to interface with any other suitable structural features (e.g., eyelet, hoop, L-shaped projection, etc.) alternatively (or additionally) utilized. Numerous suitable options and configurations will be apparent in light of this disclosure.

As previously noted, in some embodiments, one or more linkage elements 146 optionally may be included in the operative coupling of actuator element 142 with latching element(s) 144. The quantity, type, and arrangement of such optional linkage elements 146 may be customized, as desired for a given target application or end-use.

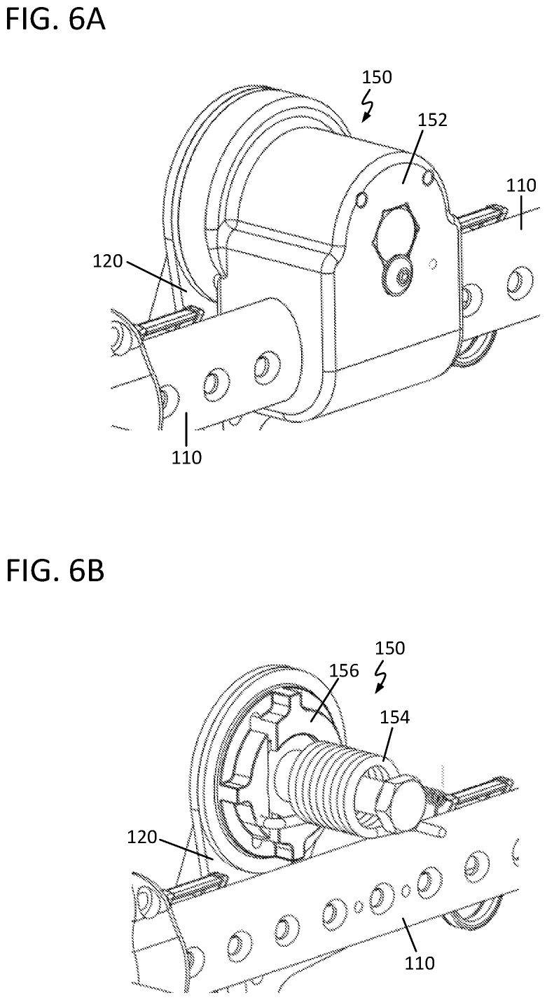

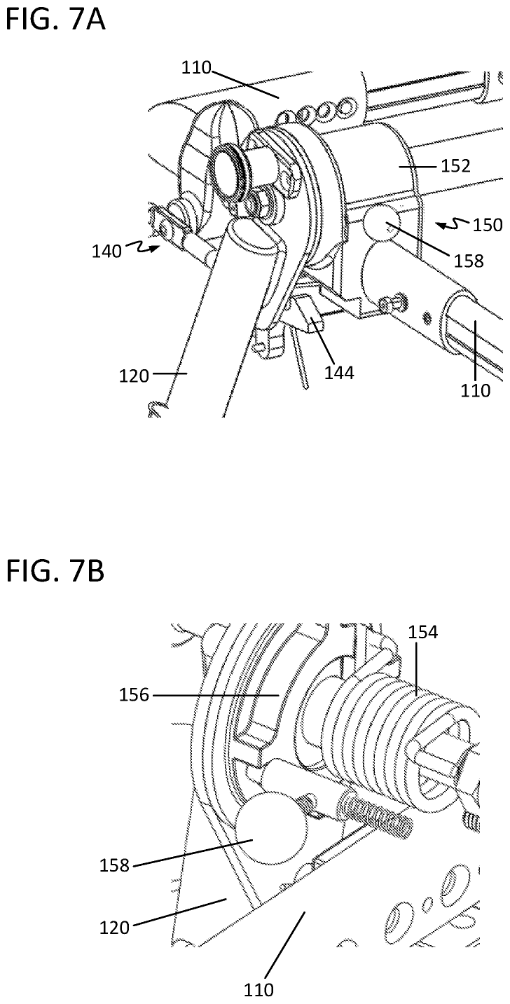

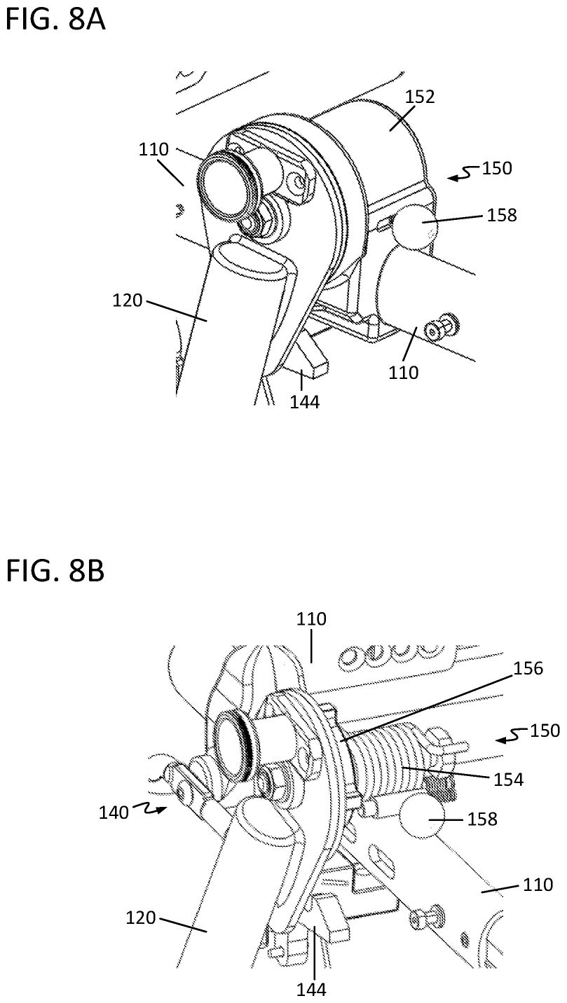

Furthermore, as previously noted, device 10 may include one or more adjustable knuckle clamp assemblies 150. For instance, consider FIGS. 6A-6B, FIGS. 7A-7B, and FIGS. 8A-8B, which illustrate several views of an adjustable knuckle clamp assembly 150 of device 10 configured in accordance with an embodiment of the present disclosure. As can be seen, a given knuckle clamp assembly 150 may include a housing 152 at least partially housing a tensioning element 154, a tension selector element 156, and a tension locking element 158. Each of these elements is discussed in turn below.

Tensioning element 154 may be configured, in accordance with some embodiments, to provide a biasing force which tends to resist transitioning of device 10 from the upright state to the collapsed state. To that end, tensioning element 154 may be (or otherwise may include), for example, a spring or other suitable biasing/restorative force member. In an example case, tensioning element 154 may be a pre-wound torsion spring with straight offset legs, one of which may be interfaced with tension selector element 156 (discussed below), and the other of which may be interfaced with some interior feature or surface of housing 152. The type of tensioning element 154 (as well as the initial quantity of turns/windings, if any) may be customized, as desired for a given target application or end-use.

Tension selector element 156 may be configured, in accordance with some embodiments, to limit (or otherwise designate) the restorative force provided by tensioning element 154. To that end, tension selector element 156 may be (or otherwise may include), for example, a disc, plate, or collar with one or more features (e.g., slots, grooves, shoulders, etc.) that may interface with tensioning element 154 to provide for greater or lesser tensioning (e.g., compression or extension loading) thereof, as desired. In an example case, tension selector element 156 may be an annular or semi-annular body having a plurality of radially extending shoulder-like projections against which a portion (e.g., a leg) of tensioning element 154 may abut. By changing which projection tensioning element 154 abuts, the restorative force of tensioning element 154 may be increased or decreased accordingly. In this manner, a user may adjust the tensioning of the one or more knuckle clamp assemblies 150 and, thus, adjust device 10 to accommodate quadrupeds of various sizes, weights, and mobility levels.

Tension locking element 158 may be configured, in accordance with some embodiments, to lock tension selector element 156 at a given tension setting (for tensioning element 154). To that end, tension locking element 158 may be (or otherwise may include), for example, a pin that may interface with tension selector element 156 to prevent inadvertent change in the tensioning level (e.g., such as by fixing the positioning of tension selector element 156). In an example case, tension locking element 158 may be a spring-loaded detent pin that may be brought into and out of contact with tension selector element 156 (e.g., at a shoulder-like projection thereof). In this manner, a user may toggle between modes in which the tension setting may be fixed or adjusted. More specifically, to adjust the tension setting of a given knuckle clamp assembly 150 (and, thus, adjust the relative ease of collapsing device 10), a user may disengage tension locking element 158, thus permitting adjustment of tension selector element 156 to a given desired tension setting for tensioning element 154. Once the desired tension setting is achieved, the user then may reengage tension locking element 158, fixing tension selector element 156 at such setting.

### Operation

As discussed herein, device 10 may be configured, in accordance with some embodiments, to enable a user to facilitate a mobility-challenged quadruped in sitting and/or laying down in a safe, natural, and comfortable manner. In further detail, with device 10 in an upright position and a quadruped situated within frame 110, a user may actuate actuator element 142 by hand (or otherwise), thereby causing latching element(s) 144 to disengage from pin(s) 122. Consequently, as the quadruped initiates a “sitting down” motion (e.g., under the action of gravity and/or with user assistance), leg(s) 120 may pivot up alongside frame 110, transitioning from an orientation generally perpendicular to frame 110 to an orientation generally parallel to frame 110, thus transitioning device 10 from an upright state to a collapsed state. In the collapsed state, the quadruped may maintain a sitting or lying down position, as desired.

When the quadruped thereafter attempts to move forward (e.g., under its own power using its forelegs and/or with user assistance) to resume a walking posture, wheel(s) 132, as locked by the interfacing of pawl(s) 138 with gear(s) 136 within hub(s) 134, may help to drive device 10 back up to its upright state. In the process, leg(s) 120 may pivot down alongside frame 110, transitioning from an orientation generally parallel to frame 110 to an orientation generally perpendicular to frame 110, thus transitioning device 10 from a collapsed state to an upright state. In entering the upright state, latching element(s) 144 automatically may reengage with pin(s) 122, thereby securing leg(s) 120 in position and, thus, securing device 10 in the upright state. Also, in entering the upright state, pawl(s) 138 may disengage gear(s) 136, thereby once again allowing free travel of device 10 in the upright state. In the process, actuator element 142 once again may become actuatable for the next time the user wishes to assist the quadruped in sitting or lying down utilizing device 10.

### Further Examples

The following examples pertain to some further configurations of the disclosed wheelchair device, from which numerous permutations and combinations will be apparent.

Example 1 is a wheelchair device for a quadruped, the wheelchair device including: a frame configured to have the quadruped situated therein; at least one leg connected to the frame; at least one wheel assembly connected to the at least one leg; and an actuator assembly operatively coupled with the at least one leg, the actuator assembly including: an actuator element configured to be actuated by a user; and at least one latching element configured to be engaged with at least one structural feature of the at least one leg; wherein the actuator element is operatively coupled with the at least one latching element such that actuation of the actuator element by the user causes disengagement of the at least one latching element from the at least one structural feature to permit the wheelchair device to transition from an upright state to a collapsed state.

Example 2 includes the subject matter of any of Examples 1 and 3-16, wherein in being configured to be actuated by the user, the actuator element is configured to be manually pulled or pushed toward the frame by the user.

Example 3 includes the subject matter of any of Examples 1-2 and 4-16, wherein the actuator element includes a handle.

Example 4 includes the subject matter of any of Examples 1-3 and 5-16, wherein the handle is configured as an elongate bar extending generally perpendicular to a longitudinal length of the frame.

Example 5 includes the subject matter of any of Examples 1-4 and 6-16, wherein the at least one structural feature is configured as a pin extending from the at least one leg into an interior region of the frame.

Example 6 includes the subject matter of any of Examples 1-5 and 7-16, wherein the frame is configured to at least partially accommodate hindquarters of the quadruped.

Example 7 includes the subject matter of any of Examples 1-6 and 8-16, wherein the at least one wheel assembly includes: a wheel; and a ratchet assembly including: a gear operatively connected with the wheel; and a pawl configured to operatively interface with the gear to prevent rotation of the wheel in one direction.

Example 8 includes the subject matter of any of Examples 1-7 and 9-16, wherein the pawl is configured as a pendulum latch.

Example 9 includes the subject matter of any of Examples 1-8 and 10-16, the pawl is configured to: prevent rotation of the wheel in the one direction when the wheelchair device is in the collapsed state; and permit rotation of the wheel in two directions when the wheelchair device is in the upright state.

Example 10 includes the subject matter of any of Examples 1-9 and 11-16, wherein: the at least one wheel assembly further includes a hub disposed adjacent to the wheel; and the ratchet assembly is at least partially disposed within the hub.

Example 11 includes the subject matter of any of Examples 1-10 and 12-16, wherein the wheelchair device further includes at least one adjustable knuckle clamp assembly connected to the at least one leg and to the frame, wherein the at least one knuckle clamp assembly is configured to orient the at least one leg with respect to the frame.

Example 12 includes the subject matter of any of Examples 1-11 and 13-16, wherein the at least one adjustable knuckle clamp assembly includes: a tensioning element; a tension selector element interfaced with the tensioning element; and a tension locking element interfaced with the tension selector element.

Example 13 includes the subject matter of any of Examples 1-12 and 14-16, wherein the tensioning element includes a torsion spring.

Example 14 includes the subject matter of any of Examples 1-13 and 15-16, wherein the tension selector element includes one or more structural features configured to interface with the tensioning element so as to change a tension level provided via interfacing of the tensioning element with the tension selector element.

Example 15 includes the subject matter of any of Examples 1-14 and 16, wherein the tension locking element includes a detent pin configured to interface with the tension selector element so as to fix a tension level provided via interfacing of the tensioning element with the tension selector element.

Example 16 includes the subject matter of any of Examples 1-15, wherein the at least one wheel assembly is connected to the at least one leg at an end of the at least one leg which is distal to the at least one adjustable knuckle clamp assembly.

Example 17 is a wheelchair device for a quadruped, the wheelchair device including: a frame configured to at least partially accommodate hindquarters of the quadruped; one or more legs connected to the frame by a corresponding one or more adjustable knuckle clamp assemblies; one or more wheel assemblies connected to the one or more legs; and an actuator assembly operatively coupled with the one or more legs and configured to transition the wheelchair device from an upright state in which the one or more legs are oriented substantially perpendicular to a longitudinal length of the frame to a collapsed state in which the one or more legs are oriented substantially parallel to the longitudinal length of the frame, the actuator assembly including: an actuator element configured to be actuated by a user; and one or more latching elements configured to be engaged with the one or more legs; wherein the actuator element is operatively coupled with the one or more latching elements such that actuation of the actuator element by the user causes disengagement of the one or more latching elements from the one or more legs to permit the wheelchair device to transition from the upright state to the collapsed state.

Example 18 includes the subject matter of any of Examples 17 and 19-20, wherein the one or more wheel assemblies each include: a wheel; a gear operatively connected with the wheel; and a pawl configured to operatively interface with the gear to prevent rotation of the wheel in one direction when the wheelchair device is in the collapsed state, wherein the pawl is configured as a pendulum latch.

Example 19 includes the subject matter of any of Examples 17-18 and 20, wherein the one or more adjustable knuckle clamp assemblies each include: a pre-wound torsion spring; a selector plate with a plurality of stops that provide a corresponding plurality of tension levels for the pre-wound torsion spring; and a detent pin configured to serve as an index stop that allows the user to set the tension level of the pre-wound torsion spring by changing a number of winds of the pre-wound torsion spring.

Example 20 includes the subject matter of any of Examples 17-19, wherein the actuator element includes a handle configured to be manually pulled or pushed by the user toward a rear portion of the frame.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

What is claimed is:

1. A wheelchair device for a quadruped, the wheelchair device comprising:
a frame configured to have the quadruped situated therein;
at least one leg connected to the frame;
at least one wheel assembly connected to the at least one leg; and
an actuator assembly operatively coupled with the at least one leg, the actuator assembly comprising:
an actuator element configured to be actuated by a user; and
at least one latching element configured to be engaged with at least one structural feature of the at least one leg,
wherein the actuator element is operatively coupled with the at least one latching element such that actuation of the actuator element by the user causes disengagement of the at least one latching element from the at least one structural feature to permit the wheelchair device to transition from an upright state to a collapsed state.

2. The wheelchair device of claim 1, wherein in being configured to be actuated by the user, the actuator element is configured to be manually pulled or pushed toward the frame by the user.

3. The wheelchair device of claim 2, wherein the actuator element comprises a handle.

4. The wheelchair device of claim 3, wherein the handle is configured as an elongate bar extending generally perpendicular to a longitudinal length of the frame.

5. The wheelchair device of claim 1, wherein the at least one structural feature is configured as a pin extending from the at least one leg into an interior region of the frame.

6. The wheelchair device of claim 1, wherein the frame is configured to at least partially accommodate hindquarters of the quadruped.

7. The wheelchair device of claim 1, wherein the at least one wheel assembly comprises:
a wheel; and
a ratchet assembly comprising:
a gear operatively connected with the wheel; and
a pawl configured to operatively interface with the gear to prevent rotation of the wheel in one direction.

8. The wheelchair device of claim 7, wherein the pawl is configured as a pendulum latch.

9. The wheelchair device of claim 7, wherein the pawl is configured to:
prevent rotation of the wheel in the one direction when the wheelchair device is in the collapsed state; and
permit rotation of the wheel in two directions when the wheelchair device is in the upright state.

10. The wheelchair device of claim 7, wherein:
the at least one wheel assembly further comprises a hub disposed adjacent to the wheel; and
the ratchet assembly is at least partially disposed within the hub.

11. The wheelchair device of claim 1, further comprising at least one adjustable knuckle clamp assembly connected to the at least one leg and to the frame, wherein the at least one knuckle clamp assembly is configured to orient the at least one leg with respect to the frame.

12. The wheelchair device of claim 11, wherein the at least one adjustable knuckle clamp assembly comprises:
a tensioning element;
a tension selector element interfaced with the tensioning element; and
a tension locking element interfaced with the tension selector element.

13. The wheelchair device of claim 12, wherein the tensioning element comprises a torsion spring.

14. The wheelchair device of claim 12, wherein the tension selector element comprises one or more structural features configured to interface with the tensioning element so as to change a tension level provided via interfacing of the tensioning element with the tension selector element.

15. The wheelchair device of claim 12, wherein the tension locking element comprises a detent pin configured to interface with the tension selector element so as to fix a tension level provided via interfacing of the tensioning element with the tension selector element.

16. The wheelchair device of claim 11, wherein the at least one wheel assembly is connected to the at least one leg at an end of the at least one leg which is distal to the at least one adjustable knuckle clamp assembly.

17. A wheelchair device for a quadruped, the wheelchair device comprising:
a frame configured to at least partially accommodate hindquarters of the quadruped;
one or more legs connected to the frame by a corresponding one or more adjustable knuckle clamp assemblies;
one or more wheel assemblies connected to the one or more legs; and
an actuator assembly operatively coupled with the one or more legs and configured to transition the wheelchair device from an upright state in which the one or more legs are oriented substantially perpendicular to a longitudinal length of the frame to a collapsed state in which the one or more legs are oriented substantially parallel to the longitudinal length of the frame, the actuator assembly comprising:
an actuator element configured to be actuated by a user; and
one or more latching elements configured to be engaged with the one or more legs,
wherein the actuator element is operatively coupled with the one or more latching elements such that actuation of the actuator element by the user causes disengagement of the one or more latching elements from the one or more legs to permit the wheelchair device to transition from the upright state to the collapsed state.

18. The wheelchair device of claim 17, wherein the one or more wheel assemblies each comprise:
a wheel;
a gear operatively connected with the wheel; and
a pawl configured to operatively interface with the gear to prevent rotation of the wheel in one direction when the wheelchair device is in the collapsed state, wherein the pawl is configured as a pendulum latch.

19. The wheelchair device of claim 17, wherein the one or more adjustable knuckle clamp assemblies each comprise:
a pre-wound torsion spring;
a selector plate with a plurality of stops that provide a corresponding plurality of tension levels for the pre-wound torsion spring; and
a detent pin configured to serve as an index stop that allows the user to set the tension level of the pre-wound torsion spring by changing a number of winds of the pre-wound torsion spring.

20. The wheelchair device of claim 17, wherein the actuator element comprises a handle configured to be manually pulled or pushed by the user toward a rear portion of the frame.
